(19) United States
(12) Patent Application Publication
(10) Pub. No.: US 2011/0268909 A1
(43) Pub. Date: Nov. 3, 2011

(54) Process for Packaging Tacky Polyester Resins

(75) Inventors: Darius K. Deak, Haverhill, MA (US); Herve Philippe Burriez, Vineuil (FR)

(73) Assignee: BOSTIK, INC., Wauwatosa, WI (US)

(21) Appl. No.: 12/975,645

(22) Filed: Dec. 22, 2010

Related U.S. Application Data
(60) Provisional application No. 61/291,422, filed on Dec. 31, 2009.

(51) Int. Cl. B32B 27/36; B65B 11/00

(52) U.S. Cl. 428/76; 53/461

(57) ABSTRACT

A method for packaging plastic material using a film to surround the material, and more particularly to a method for packaging a copolyester, and the resulting package formed thereby. The method is preferably a coextrusion process for packaging an amorphous or semi-crystalline copolyester having a low glass transition temperature by extruding it through a die orifice, and coextruding a copolyester polymeric film having a high glass transition temperature to surround the low glass transition copolyester. The coated low glass transition copolyester may then be formed into individual packaged units having a finite size and shape.

### BACKGROUND OF THE INVENTION

The present invention relates to a method for packaging tacky plastic material having a finite size and shape using a film to surround the material, and more particularly to a method for packaging amorphous and semi-crystalline polyester resins using a coextrusion process, and the resulting package formed thereby.

Low glass transition temperature (Tg) amorphous and semi-crystalline polyester resins are useful as adhesives. Typically, such resins are supplied in the form of solid blocks, granulated blocks, or pellets, or in liquid form by being solvated in common solvents.

These Low Tg amorphous and semi-crystalline polyester resins are typically used commercially by solvating in common solvents. The polymer-solvent solution is then coated on various substrates (films, foils, nonwovens, paper, etc.) and used as either a laminating adhesive (laminating the coated substrate to another substrate), a heat seal coating, a top coat, or a tie layer. In most cases the low Tg resins are crosslinked using various curatives (such as for example isocyanates, melamines, aziradines, and silanes) to improve temperature and solvent resistance. However, since low glass transition temperature amorphous and semi-crystalline polyester resins are typically sticky and/or soft at room temperature, there are problems associated with handling and packaging of such resins. Regardless of the form in which it is provided, a low Tg tacky polyester resin not only sticks or adheres to hands, mechanical handling devices and to itself, but it also readily picks up dirt and other contaminates. In addition, the individual pieces of a low Tg tacky polyester resin will tend to flow or block together into a single solid mass rendering such material difficult to be handled and/or packaged. As a result, containment during shipment and/or storage periods is a critical aspect of delivering a low Tg tacky polyester resin.

To address this troublesome difficulty, those skilled in the art have turned to packaging techniques such as, for example, shipping tacky resins and/or adhesive compositions in containers, such as 55 gallon drums, polyethylene bags, or silicone coated corrugated or particleboard boxes, or alternatively, silicone coated polymer-based trays which are typically manufactured from a high density polyethylene. While these solutions will solve the problem, noted above, in some industrial environments and applications, it presents a multiplicity of additional difficulties, and other drawbacks, which have detracted from their usefulness. For example, the more traditional methods of shipping adhesive compositions create problems related to the cost and disposal of the packaging materials. In this regard, the silicone coated polymer based trays employed for shipping some types of adhesive compositions are relatively expensive to purchase, and the presence of a silicone coating may contaminate the resin and makes such a container very difficult if not impossible to recycle. Therefore, these trays, or other similar containers, in many instances, are merely collected and disposed of in landfill sites, thereby creating a troublesome source of pollution. Further, these silicone coated containers create other difficulties in that under certain environmental circumstances a great deal of physical force must be applied to the adhesive to extract it from these containers, making the adhesive difficult and inconvenient to handle.

In response to the shortcomings noted above, some manufacturers have attempted to produce synthetic trays which are readily recyclable, or which can, alternatively, be returned and reused for subsequent shipments of adhesives. Recyclable containers, although attractive by their relative simplicity, have not been embraced widely in the industry due to an obvious lack of commercial appeal. More particularly, the development of a new, more readily recyclable tray has produced, as a byproduct, retooling, and other manufacturing expenses, which have been substantial in some respects, and which have worked as a deterrent to the adoption of this solution as an answer to the aforementioned shortcomings. Further, reusable containers are generally manufactured from a thicker gauge material to lend a measure of durability to the containers such that they may survive multiple uses. As a result, the per unit cost of such containers is usually significantly greater than disposable containers. Additionally, the costs attendant to collection and returning the spent containers or trays to the manufacturers for subsequent use has further caused this proposed solution to be quite expensive and therefore commercially unacceptable.

Many other different approaches have been tried to package tacky plastic materials like low Tg polyester resins. One approach is to use a package material that is meltable together with and blendable into the molten adhesive composition itself just prior to application.

In one such method, molten adhesive is fed directly into a film formed in the shape of a tube, and then individual packaged adhesive units are formed by squeezing, sealing and cutting the tube. Such a process is sometimes referred to as a “form, fill and seal” process. For example, U.S. Pat. No. 5,373,682 describes a method where molten adhesive is pumped into a cylindrically-shaped tube of plastic film while the exterior surface of the film is sprayed with cooling water. The resultant individual packages referred to as “cartridges” are allowed to cool until the adhesive solidifies. Another example of making cartridges of this type is illustrated in U.S. Pat. No. 5,392,592.

In U.S. Pat. No. 6,430,898, low complex viscosity film materials are used to surround a hot melt adhesive. The film material is composed of an ethylene/α-olefin interpolymer, which is a metallocene or single-site catalyzed interpolymer of ethylene and at least one C₃-C_{20α}-olefin.

Rouyer et al, in U.S. Pat. No. 5,257,491, and U.S. Reissue Pat. No. 36,177 approaches the problem of shipping cold flowing, pressure sensitive hot melt adhesive compositions by designing a package which encloses the pressure sensitive adhesive and is meltable along with the adhesive. In this instance, the package is a polymer based film which will melt when exposed to the heat of application machinery.

In PCT applications WO 02/061009 and WO 04/037671, it is claimed that low temperature adhesive application can be achieved when using low melting point (below 100° C.) polymers as packaging films. Ethylene vinyl acetate (EVA) copolymers, ethylene methyl acrylate (EMA) copolymers, polyethylene copolymers, polypropylene copolymers or combinations thereof are suggested for use as the packaging film.

Yet another approach is to first form the adhesive into a finite size and shape, and then wrap the adhesive with a plastic film. For example, U.S. Pat. No. 6,230,890 describes a method where a mass of adhesive is first cooled, and thereafter packaged in a polymeric shrink wrap film.

In some processes, the adhesive mass is first pumped into a mold and then packaged. For example, U.S. Pat. No. 5,806,285 to Rizzieri teaches a method wherein adhesive is cast in a mold to form blocks. The mold has a plurality of holes formed therein and is lined with a thin film of plastic material which is vacuum thermoformed onto the inner surface of the mold. After filling the mold with adhesive, the open top surface is covered with a thin film of plastic material which is heat sealed to the film lining the interior of the mold. The mold containing the adhesive which is now enveloped by the film is then air cooled prior to removing the packaged adhesive from the mold.

Another process using molds is taught in U.S. Pat. No. 5,401,455 to Hatfield et al. The Hatfield et al patent describes a method for packaging hot melt adhesive compositions using a mold in the form of a pan lined with a film material which has its outer surface in contact with a refrigerant gas or liquid heat sink. Hatfield et al teaches that when molten hot melt adhesive is poured into the lined pan, the adhesive is fused to some degree with the film. According to Hatfield et al this in turn improves later mixing of the film with the adhesive.

Yet another, process utilizing a mold is disclosed in U.S. Pat. No. 5,715,654 to Taylor et al. In this process, Taylor et al teaches lining a rigid mold with a thermoplastic film which is vacuum formed into the mold.

Still another process is described in U.S. Pat. No. 4,039,485 and involves the coextrusion of a sheath or coating surrounding a hot melt adhesive where the coextruded sheath material may be polyethylene.

Various other processes for packaging hot melt adhesives are illustrated in U.S. Pat. Nos. 6,155,029, 6,138,441, 5,669,207 and 5,942,082.

In all of the references cited above, the material used to package the adhesive or other plastic material is a high molecular weight polymer, a modified high molecular weight polymer, or a combination of high molecular weight polymers. Typical examples are high molecular weight ethylene vinyl acetate (EVA) copolymer, or high molecular weight ethylene-acrylate copolymer, or high molecular weight low-density polyethylene, or a high molecular weight metallocene or single-site or Ziegler-Natta copolymer of ethylene. While these materials appear to be somewhat effective for their intended purposes, they also have readily apparent shortcomings which have detracted from their usefulness. These compositions, once melted, have a propensity under certain manufacturing conditions to not homogeneously mix with the adhesive which was enclosed therein because of the high viscosity of the polymeric material. As a result, these high molecular weight materials may lead to dephasing from the adhesive and therefore form lumps of crosslinked or gelled particles or char, which can clog filters and nozzles in conventional production machinery. Further, experience has shown that the addition of even a few percent, by weight, of these above-identified high molecular weight compositions to a typical hot melt or pressure sensitive adhesive composition has an adverse effect on the ability of the adhesive to form an effective bond with assorted target substrates. None of the references cited above teach how to formulate a film or coating composition in order to prevent this kind of defect.

Knowing the above shortcomings it has also been suggested to package adhesives by formulating a film or a coating composition that is more easily meltable together with and/or more easily blendable into the molten adhesive composition itself just prior to application. The following illustrate some examples of this approach.

In EP 0957029, a coextrusion system is described where a tube of thermoplastic material is extruded and surrounded with a coextruded molten film which is pinched at regular intervals to create individual packages. The coextruded outer film is merely described as being a “non-adhesive” but it is also stated that the film composition may contain 1-5% by weight of the adhesive product.

Another illustration of this approach is shown in U.S. Pat. No. 5,865,927 where the packaging process involves: a) extruding hot melt adhesive through a die, b) spraying the surface of the extruded adhesive with a molten film forming polymeric material, the material being selected so that it will not detract from the properties of the adhesive composition when remelted therewith, c) heating the surface of the coated adhesive at a temperature and for a period of time sufficient to re-melt the film forming polymer so as to form a continuous coating thereof yet insufficient to melt the adhesive, and d) cooling the thus coated adhesive mass to a temperature suitable for handling. The film composition described in the '927 patent uses an EVA copolymer or a SEBS block-copolymer, an aromatic hydrocarbon resin, a paraffin wax, and an antioxidant/stabilizer.

Another example is described in U.S. Pat. Nos. 5,112,552, and 5,292,468, where hot melt adhesive compositions are poured into a mold in the form of a lined pan. The lining is sprayed onto the interior surface of the mold. Examples of the film composition used include an EVA copolymer, polyethylene copolymers, a paraffin wax, waxy forms of antioxidants, ethylene maleic anhydride, ethylene acrylic acid and natural rubbers.

EP 0557573 discloses a packaging composition for cold-flowing hot melt adhesive compositions. The packaging composition contains a blend of styrene-isoprene-styrene block copolymer, an aromatic hydrocarbon resin, mineral oil, a wax, and an antioxidant/stabilizer.

U.S. Pat. Nos. 4,748,796 and 4,755, 245 disclose forming a protective coating for an adhesive by electrostatically coating a mold or cavity with a powder screen and then pouring molten hot melt adhesive into the mold. Powder materials are described as made of a wax, or as made of a polymer, or as made of a hot melt formulation, with no further specific formulations described.

Other approaches deal with pellet coating, like in U.S. Pat. No. 6,120,899, where a hot melt composition may be used to coat the pellets. The hot melt composition is described as containing a polymer, tackifying resin, and a small amount of wax. In U.S. Pat. No. 6,238,732, a pelletizing aid containing less than 10 wt % wax is used to coat adhesive pellets. In addition, several underwater pelletizing processes which form pellets of soft or tacky plastic products, like in U.S. Pat. No. 5,041251, use anti-blocking agents that are applied either by extruding the pellets into a liquid emulsion containing the anti-blocking agent, or applied to the surface of the extruded pellets after the pellets are dried as solid particles. The anti-blocking agent is commonly a mineral powder or micronized wax powder or micronized polymer powder.

In some packaging processes, regardless of the form of the pieces of tacky or soft plastic material to be packaged, the material may be coated with wax, or with a low molecular weight ethylene based polymer. In U.S. Pat. Nos. 5,942,304 and 5,733,645, polyethylene wax is used to improve the cuttability of soft and tacky materials. Materials used to form a coating under these conditions, however, typically cannot be formed into a continuous film, substantially surrounding the entire surface of the adhesive or soft plastic material pieces.

In the references cited above, if any benefit can be seen from using a lower-molecular-weight film composition or using a film material, which might include a wax, there are also apparent shortcomings which have detracted from their usefulness. First, wax or wax-based materials are usually too brittle to be formed into continuous films and/or to be used as packaging films as they can not be substantially stretched, folded or pinched without creating cracks and/or breaks therein which would lead to the adhesive or soft or tacky product's leakage from inside the package. This cracking and/or breaking behavior can also happen due to the intrinsic cold flow and subsequent deformation of the adhesive or plastic material during storage or shipment.

Further, none of the formulations containing a wax or lower-molecular-weight compounds described as a protective film in the references cited above would withstand severe shipment and storage conditions like what would be experienced under stacking pressure in a container on a truck, on a train or in a boat, in industrial regions where sunny weather conditions can be around 40° C. to 50° C., even reaching about 60° C. as a peak temperature during several hours. In these conditions, a thermoplastic film would typically have a tendency to get softer, to eventually melt, to become potentially tacky or become progressively plasticized due to the presence of a low molecular weight compound in the packaged material. This is a common failure, particularly in the adhesive industry that needs to be avoided in order to properly handle and use the packaged plastic material.

Therefore, it has long been known that it would be desirable to have an improved packaging film for enclosing low Tg tacky polyester resins. The film material should advantageously be operable to reduce the attendant waste produced as a result of utilizing conventional packaging techniques, and which further reduces or substantially eliminates any troublesome clogging or other deleterious effects which may occur when it is used in combination with conventional adhesive application machinery. Further, the packaging film should have no substantial effect on the ability of the adhesive composition to form effective bonds on the desired substrates, and should not block to similar films at elevated storage and shipment temperatures. The packaging film should also be inexpensive to manufacture and sell, and further be characterized by its ease of utilization.

### SUMMARY OF THE INVENTION

The present invention provides a method for packaging low glass transition temperature (Low Tg), tacky (amorphous or semi-crystalline), solvent soluble copolyester resin compositions using a high glass transition temperature (High Tg) non-tacky, solvent soluble, copolyester polymeric film to surround the Low Tg copolyester resin material, and the resulting package formed thereby. Any process to package the Low Tg tacky copolyester resin material can be potentially used to form or apply the film around the Low Tg copolyester resin material. The packaging film is particularly adapted to a coextrusion process, but is readily adaptable to any process where a film is used to surround or package a plastic material.

In accordance with the present invention, there is provided a method for packaging a Low Tg tacky copolyester resin material comprising the steps of providing a Low Tg tacky copolyester resin material of finite size and shape, and surrounding the Low Tg copolyester resin material with a High Tg non-tacky copolyester polymeric film. The composition of the Low Tg tacky copolyester resin material and the High Tg non-tacky copolyester polymeric film is selected so that both may be readily solvated in an appropriate solvent prior to use. In accordance with a preferred embodiment for the method of the present invention, there is provided a method for packaging a plastic mass of amorphous or semi-crystalline Low Tg copolyester resin material, comprising the steps of extruding a plastic mass of tacky Low Tg copolyester resin material through a die orifice, and coextruding a High Tg non-tacky copolyester polymeric film to surround the Low Tg plastic mass. The High Tg polymeric film comprises a solvent soluble composition having a high Tg of 60° C. or more as measured by ASTM method D 3418. Any type of Low Tg tacky, soluble copolyester resin plastic mass having a Tg of 40° C. or less as measured by ASTM method D 3418 can be packaged or surrounded by the High Tg polymeric film.

The present invention also provides a solvent soluble plastic product package. The package includes a tacky soluble Low Tg copolyester resin plastic mass, having a finite size and shape, such as a pillow, pellet, or cylindrical shape, and a non-tacky High Tg copolyester resin polymeric film which surrounds the Low Tg plastic mass. Preferably, the polymeric film has a thickness of 10 microns to 2,000 microns. The polymeric film comprises 0.5% to 30% by weight, preferably 0.5% to 2% by weight of the package while the resin plastic mass comprises 70% to 99.5% by weight, preferably 98% to 99.5% by weight, of the package.

An advantage of the process of the present invention is that it can be used to package virtually any type of tacky and low Tg amorphous or semi-crystalline copolyester resin composition. Another advantage is that the High Tg polymeric film composition may be solvated and combined with the Low Tg plastic material, during the manufacturing process, thereby eliminating any waste packaging issues. A further advantage is that the High Tg packaging film of the present invention, when solvated and combined with the Low Tg plastic mass composition in a solvator/churn during the manufacturing application process, is substantially compatible with the Low Tg plastic mass or material composition itself and therefore does not have any substantial deleterious effects on the physical, or performance characteristics, of the Low Tg plastic mass or material and does not substantially adversely impact the operation of the application equipment. Another important advantage of the present film composition is that it is substantially resistant to migration therethrough of low molecular weight compounds from the adhesive and/or plastic mass it surrounds or from any external source it might contact, and therefore results in a package which is substantially non-blocking when exposed to environmental conditions, typically 40° C., 50° C., 60° C., or 70° C. for a few hours to about 7 days or more.

Currently, copolyester resin products such as Vitel 3300B, 3300S, 3350B, 3200B, 3650B, and 3550B are sold in six or eight pound bags (with 5 bags per box). The bags are made out of polyethylene and a user must strip off the outer bag prior to solvating the Vitel resins. The polyethylene film is not soluble in the same kinds of solvents as the polyester resins, and therefore cannot be included in the same solvation process as that used for the resin. For customers who buy large quantities of resin, this entails a significant amount of labor and waste.

As noted above, low Tg tacky copolyester resins currently are packaged in polyethylene bags. These bags need to be stripped off at the customer. This invention will eliminate the need for the polyethylene (PE) bags. This technology will also eliminate several processing steps. The resin will preferably be coextruded directly from the reactor which will eliminate dropping the resin into pans, freezing, grinding and bagging the resins. The elimination of all these steps will allow for a considerable saving of labor and materials. Also the elimination of these process steps will improve plant safety and will improve product quality (through the elimination of several steps that introduce possible contamination into the product).

Also, because this is a more user friendly packaging system, the market for these resins may be opened to a global level. The current 6 or 8 pound resin bags are too difficult for many users to solvate (for example, they can shear the pins off a churn). The new packages will be much smaller (20 to 500g) which will be easier for customers to handle.

### DETAILED DESCRIPTION OF THE INVENTION

The High Tg non-tacky copolyester polymeric film composition of the present invention may be utilized to package virtually any type of Low Tg amorphous or semi-crystalline tacky copolyester plastic material (also oftentimes referred to in this description as a “plastic mass”), which compositions and/or compounds, particularly copolyester resins, are soft, pliable and/or tacky at an ambient temperature of 60° F. Preferably, the High Tg copolyester polymer film composition disclosed herein is used to package Low Tg copolyester compositions, and is especially intended for packaging Low Tg copolyester resins. “Glass Transition Temperature” (abbreviated as “Tg” herein) is defined as a second order phase transition where an amorphous material becomes glassy and brittle upon cooling below and becomes soft or ductile upon heating as is well known by those skilled in this art.

The polymeric film composition can be utilized with virtually any packaging process where a film is surrounding a plastic material, especially a soft, pliable and/or tacky material such as a Low Tg amorphous or semi-crystalline copolyester resin composition. Thus, the polymeric film composition of the present invention can be utilized with Low Tg tacky copolyester resin plastic materials which are packaged by extrusion, coextrusion, trays, molds, as well as form, fill, and seal technologies, spray coating, or by any other specific technique, such as those described in the prior art. In fact, the polymeric film composition described herein could even be utilized with hand-wrapping processes. Thus, the polymeric film described herein can be formed simultaneously with the plastic material, as for example in a coextrusion process, or it can be formed separately, stored in roll form and later utilized to package the plastic material, as for example in trays, molds or form, fill and seal technologies. In the latter situation, the film material can be formed into a film (e.g. by extrusion), rolled, stored, shipped and then unwound to package the plastic material.

As used herein, the term “plastic material” or “plastic mass” is intended to describe any Low Tg tacky copolyester resin, compound or composition that is flowable with or without the application of heat thereto, and that can be molded, cast, squeezed or pressed into various shapes. This resin may be either amorphous or semi-crystalline. Thus, the term “plastic material” or “plastic mass” encompasses, but is not limited to, soft and pliable Low Tg tacky copolyester resin compositions, e.g., a blend of polymers one of which is the Low Tg tacky copolyester resin, or a blend of the Low Tg tacky copolyester resin with substituents such as plasticizers, tackifiers, waxes, stabilizers, colorants, crosslinking agents and fluorescing agents, to name a few, or Low Tg tacky copolyester resin compounds, per se, and blends of each or all of the above materials It should thus be noted that the terms “plastic mass” and “plastic material” are intended to be broader than what has been called “plastics” as the term “plastics” is typically used to denote mixtures of materials (i.e. a composition), one of which is a natural or synthetic polymer, that are capable of being formed into a fiber, sheet or solid, or cast in a mold, at one stage of processing and subsequently becoming more rigid at another stage.

As used herein, the term “Low Tg tacky copolyester resin composition” refers to any aggregate, mixture, mass or body formed by combining two or more ingredients which employs a Low Tg amorphous or semi-crystalline copolyester resin compound as one or more component thereof, and which has the property of softening and becoming moldable when heated and of hardening and becoming relatively more rigid again when cooled, although the degree of rigidity and hardness may vary widely. A “Low Tg tacky copolyester resin compound” is any individual or single Low Tg amorphous or semi-crystalline copolyester resin raw material that becomes or remains permanently hard and unmoldable when cured, although the degree of rigidity and hardness may vary widely. Typical examples of Low Tg tacky copolyester resin compounds include any amorphous copolyester resin intended to be transformed or to be added to an end-used product, or to be a raw material for a synthetic or chemical process. Typical Low Tg amorphous copolyester resin compounds include, but are not limited to, Vitel 3200B, Vitel 3300B, Vitel 3300S, Vitel 3350B, Vitel 3550B, or Vitel 3650B, available from Bostik, Inc. Typcial Low Tg semi-crystalline copolyester resin compounds include, but are not limited to Vitel KP7908, Vitel KP7962, Vitel KP9715, and Vitel 1801, also available from Bostik, Inc.

As used herein, the term “thermoplastic composition” refers to any aggregate, mixture, mass or body formed by combining two or more ingredients which employs a thermoplastic compound as one or more component thereof, and which has the property of softening and becoming moldable when heated and of hardening and becoming relatively more rigid again when cooled, although the degree of rigidity and hardness may vary widely. A “thermoplastic compound” is any individual or single material that becomes or remains soft and moldable when subjected to heat, and becomes harder and relatively more rigid again when cooled, although the degree of rigidity and hardness may vary widely. Typical examples of thermoplastic compounds include any plasticizer, polymer, pre-polymer, terpolymer, interpolymer, monomer or oligomer intended to be transformed or to be added to an end-used product, or to be a raw material for a synthetic or chemical process. Typical thermoplastic compounds include, but are not limited to, acrylonitrile-butadiene-styrene (ABS), acetyls, acrylics, cellulose acetates, cellulose acetate butyrates, nylons, polyesters, polycarbonates, polyethylenes, polystyrenes, polyvinyl chlorides, polyvinylidene chlorides and polytetrafluoroethylenes. The term “thermosetting composition” refers to any aggregate, mixture, mass or body formed by combining two or more ingredients which employs a thermosetting compound as one or more component thereof, and which has the property of becoming permanently hard and rigid when heated or cured. A “thermosetting compound” is any material that becomes permanently hard and unmoldable when heated or cured. Typical thermosetting compounds include, but are not limited to, alkyds, allylics, epoxies, melamines, ureas, phenolics, polyesters, silicones, and urethanes.

The term “crystalline” if employed, refers to a polymer that possesses a first order transition or crystalline melting point (Tm) as determined by differential scanning calorimetry (DSC), or equivalent technique. The term “semicrystalline” refers to a polymer having a degree of crystallinity of 30% or less as determined by differential scanning calorimetry (DSC), or equivalent technique, against a highly crystalline polypropylene standard. The term “amorphous” refers to a polymer lacking a crystalline melting point as determined by differential scanning calorimetry (DSC), or equivalent technique. The term “tacky” refers to a polymer having a surface that is somewhat sticky to the touch, and thus would encompass, for example, the above referred to amorphous and semicrystalline polymers. The term “non-tacky” refers to a polymer having a surface that does not have a sticky or adhesive quality or condition.

As used herein, the term “solvent-based adhesive composition” refers to any aggregate, mixture, mass or body formed by solvating an adhesive resin completely into an organic liquid capable of dissolving the resin without a significant change in the physical state of the liquid. Common solvents used for polyester resin adhesives include methyl ethyl ketone (MEK), ethyl acetate (EA), butyl acetate, acetone, toluene, tetrahydrofuran (THF), cyclohexanone, and/or dioxolane. Once these adhesives are fully solvated they are utilized by coating onto various substrates to be adhered. Typical application techniques include gravure coating, reverse roll coating, slot-die coating to name but a few. It is important to note that the adhesive solution needs to be 100% solvated. Any undissolved particles or gels can cause severe coating defects which can affect final adhesive and appearance performance. Once the solvent based adhesive composition is applied to the substrate some form of drying takes place e.g. via an oven, traversing heated rolls, etc. to drive off the solvent and leave predominately only the adhesive resin behind on the substrate. The adhesive coated substrate will later be joined to a second substrate to form the adhesive bond. This bond may be formed by heat, pressure, or a combination of both.

Although the polymeric film composition of the present invention can be utilized with virtually any packaging process, it is particularly adapted for a coextrusion process. In a coextrusion process, the plastic material to be packaged is generally melt blended in a mixer, single screw extruder, or twin screw extruder and then pumped, squeezed, or extruded through an appropriately sized orifice in a die while still at a temperature above or very close to the softening point of the material. The orifice and die may be of any conventional configuration and generally is such as to provide either a slot like or cylindrical like configuration for the plastic material as it is pumped through the orifice. The temperature of the die must be maintained well above the melting point of the plastic material, and is typically in the range of 100° C. to 250° C. In coextrusion, the polymeric film material of the present invention is then simultaneously extruded from the die to surround the plastic material to be packaged and thus forms a sheath or wrapping which encloses the material to be packaged. Coextrusion techniques are well known in the art, and suitable equipment for coextrusion processes are described for example in EP 0957029, in U.S. Pat. No. 5,527,491, in U.S. Reissue RE 36,177, and in U.S. Pat. No. 5,942,304. As is well known, since the materials being extruded are at elevated temperatures, the coextrusion process typically occurs under water so that the plastic material and film that surrounds the plastic material begins to cool immediately after being extruded from the die. Thereafter, the plastic material covered by the polymeric film is allowed to cool either in a water bath, or in a refrigerant medium such as chilled glycol, liquid or gaseous nitrogen, compressed carbon dioxide or the like, or under ambient conditions so that the wrapped plastic mass is sufficiently cooled for handling. The temperature of the bath is greater than the Tg of the polymeric film. This improves adhesion between the plastic material and the polymeric film. The coated extrudate can then be pinched mechanically (either when still at an elevated temperature or after cooling to a desired temperature) into a unit of desired size, shape, weight and/or portion using conventional equipment such as rollers, and subsequently sealed if necessary. The seal can be a hermetic seal, or a mechanical seal depending upon the size, shape, weight, and/or portion of the unit, but in any event, should be sufficient to prevent leaking of the plastic material during handling, storage or shipment. Finally, the coated unit mass of plastic material can be cut mechanically or by any other conventional means into individual packaged units using conventional equipment such as water jet, laser or a hot knife. Alternatively to mechanically pinching the coated extrudate, the coated extrudate can be pressed at a portion thereof and ultrasonically welded at the pressed portion; the coated extrudate is cut into a unit of desired size, shape, weight and/or portion at the pressed portion. This process is described in application EP1824741.

The resultant packaged plastic mass may be further packaged in a container or bag to reduce its exposure to the environment, moisture, or other contaminants, if necessary or desired. The container or bag could be made of the polymeric film composition of the present invention or of other film compositions, but if made from other film compositions, such container or bag may then need to be removed by conventional procedures prior to utilization of the individual coated plastic units contained therein, especially if the individual packaged plastic units contain a polyester composition intended for use in a solvator or churn. In contrast, if the container or bag is made of the polymeric film composition of the present invention, the container or bag could be solvated together with and blendable into the solvated polyester composition itself just prior to application.

The polymeric film material described herein can be utilized with a plastic material or mass, such as a thermosetting or thermoplastic polyester composition, or a solvent-based adhesive composition of any desired size, shape, weight and/or portion to provide a packaged unit. Thus, the packaged unit may be in the form of bricks, blocks, pillows, cartridges, pellets, cylinders, ribbons, or the like. It is preferable that the polymeric film of the present invention be compatible with the plastic material which it surrounds. Typically, the polymeric film composition should have physical characteristics which are compatible with and do not substantially adversely affect the inherent characteristics of a solvent-based mixture of the plastic mass and the polymeric film material, and further the polymeric film material when solvated together with the plastic mass which it surrounds to form a mixture is substantially compatible with the operation of application equipment. When the plastic mass is a polyester composition, the polymeric film should not substantially adversely affect the physical properties of the polyester mass it surrounds. However, in certain applications, it may be desirable to simply unwrap the packaged plastic mass prior to use, in which case the polymeric film wrapping could be discarded if desired. Normally, however, the polymeric film composition should be formulated to be compatible with the plastic material it packages so that the polymeric film and plastic material may be blendable together in a solvent-based mixture that is compatible with the operation of application equipment and that does not adversely affect the inherent (especially adhesive) characteristics of the material.

The polymeric film used as the skin material can be colored using any desired pigment or may be printed on using any known printing technique or in general be compounded with any useful ingredient therein which is compatible therewith.

### The Plastic Mass

The method and polymeric film composition of the present invention is adaptable to the packaging of polyester plastic material. It is especially adapted to the packaging of Low Tg amorphous or semicrystalline copolyesters, and specifically to copolyesters having a glass transition temperature (Tg) of 40° C. or below, where the handling problems are most severe. Preferably, the copolyester plastic mass has a low glass transition temperature of 35° C. or less, and most preferably 20° C. or less. Low Tg copolyesters are well known and commercially available. Examples of typical Low Tg copolyesters can be found in U.S. Pat. Nos. 3,372,148; 3,413,280; 3,423,281; and 3,386,961.

Examples of commercially available Low Tg copolyesters include Vitel 3200B, 3300B, 3300S, 3500B, 3550B, 3650B, 1801, KP7908, KP7962, KP7915; Vylon 300, 500, 516, 530, 550, 560, 630, 650, 670. “Vitel” copolyesters are available commercially from Bostik, Inc. “Vylon” copolyesters are available commercially from Toyobo Co., Ltd.

Optional additives may be incorporated into the polyester composition in order to modify particular physical properties. These additives may include colorants, such as titanium dioxide and fillers such as silica, talc, and clay, crosslinking agents, nucleating agents, reactive compounds, fire-retardant mineral or organic agents, as well as ultraviolet light (UV) absorbing agents and UV fluorescing agents.

### The Polymeric Packaging Film

The polymeric film composition of the present invention used as the improved packaging film also comprises a polyester material, but instead of being a Low Tg copolyester like the plastic mass it surrounds, it is a High Tg copolyester. High Tg copolyesters are copolyesters having a glass transition temperature of 60° C. or above. High Tg copolyesters are well known and commercially available. Examples of typical High Tg copolyesters can be found in U.S. Pat. Nos. 3,372,148; 3,413,280; 3,423,281; and 3,386,961. Examples of commercially available High Tg copolyesters include Vitel 1200B, 2100B, 2200B, 2230B, 2250B, Vylon 200, 220, 226, 240, 245, 270, 280, 290, 296, Dynapol L912, L952, L205, L206, L208, and L210. “Vitel” copolyesters are available commercially from Bostik, Inc. “Vylon” copolyesters are available commercially from Toyobo Co., Ltd. “Dynapol” copolyesters are available commercially from Evonic Industries (formerly known as Degussa AG). The preferred High Tg copolyester for use as the packaging film is Vitel 2200B.

Optional additives may be incorporated into the polyester film composition in order to modify particular physical properties. These additives may include colorants, such as titanium dioxide and fillers such as silica, talc, and clay, crosslinking agents, nucleating agents, reactive compounds, fire-retardant mineral or organic agents, as well as ultraviolet light (UV) absorbing agents and UV fluorescing agents.

The packaging film compositions of the present invention may be produced using any of the techniques known in the art. The film composition may be pelletized using conventional underwater pelletizing techniques. Other exemplary procedures are using extrusion-compounding with single or twin screws.

These film compositions, as well as the plastic mass previously described herein, can be easily characterized directly by different conventional analytical methods or after solubilization and/or semi-preparative liquid chromatography followed by a fraction-by-fraction identification, such as differential scanning calorimetry (DSC), Fourier transform infrared (bulk or surface) spectroscopy (FT IR), size exclusion chromatography (SEC), and nuclear magnetic resonance (NMR).

The viscosity of the improved packaging film of the present invention is about 50,000 to about 1,000,000 mPa.s at about 180° C. to about 280° C., as determined by employing a Brookfield Thermosel or other appropriate viscometer and utilizing the testing techniques which are set forth in ASTM Method D3236-73. Once mixed and equilibrated, the molten packaging film of the present invention can be coextruded along with the Low Tg polyester composition, as previously described herein, or can be formed into a film by casting or extruding the molten composition onto a release coated surface. Commercially available machinery for performing these manufacturing techniques may be purchased from The Nordson Company. As earlier discussed, the High Tg packaging film enclosing the Low Tg composition may be charged directly to solvator or churn thereby eliminating any waste and avoiding many of the shortcomings attendant to the use of the conventional packaging techniques discussed earlier.

The new packaging film composition may be used virtually in any packaging techniques. For example it may be sprayed or poured onto the Low Tg copolyester pieces in general, or blocks, or into molds, or transformed into a form of package item, like a bag, a thermoformed tray or a wrapping film or sheet.

Particularly the new film composition may be processed to form a film by conventional film-extrusion or film-coextrusion techniques, like extrusion-coating, cast-extrusion, blown-extrusion. The new film composition may be compounded with conventional additives in order to improve its processability in these traditional film forming techniques, and to improve film mechanical and physical final characteristics. In these processes, the film is generally extruded then cooled, slit and wound upon itself to form rolls for storage and subsequent use in commercially available filling and wrapping machinery. In this regard, the improved packaging film of the present invention can be utilized on semi-automatic multi-size filling and wrapping machines such as those manufactured under the trade designation “Mark 10I-12-A system: Inverted Horizontal Form, Fill and Seal Machine”, and which is manufactured by Premier Packing Systems, Inc. of Waukesha, Wis. Other compatible machinery may be easily selected by those skilled in the art.

The copolyester polymeric film surrounding the copolyester plastic mass has a thickness of from 10 microns to 2000 microns, preferably from 40 microns to 2000 microns, more preferably from 10 microns to 300 microns, and most preferably from 10 microns to 100 microns. Also, the copolyester polymeric film should have a high glass transition temperature of 60° C. or more, preferably 65° C. or more, and more preferably 68° C. or more.

Dissolution tests of the skin materials into the adhesive mass were conducted in the lab on 100 g adhesive samples. Depending on each case studied, a precise amount, ranging from 2 g to 50 g of the film material was added to the solvated adhesive in a glass jar at room temperature (20 to 27° C.). After allowing to solvate overnight, visual observation was made of the solvated adhesive appearance. The jar was shaken manually and allowed to sit for extended periods of time (1 day to 1 month) to visually assess the dissolvability. If no phase separation was observed after letting the mixture stand for one month, the blend was considered stable and compatible.

Brookfield viscosity of the solvated adhesives was tested according to ASTM Method D-3236 at 25° C. Tests were performed on blank adhesive samples in the same time as on contaminated adhesive samples produced in the dissolution test described above.

Ring & Ball softening point was determined with a manual unit according to ASTM Method E-28. Tests were performed on control adhesive samples in the same time as on blended adhesive samples produced in the dissolution test described above. Adhesive formulas used for this migration test were made according to the mixing procedure described above. Once the resins were solvated together, the solvent was dried off to allow the pure resin blend to be tested.

Intrinsic viscosity (IV) was measured using ASTM method D5225. IV tests are used as a relative test of polymer molecular weight. A solvent mixture of phenol:tetrachloroethane is used on a Viscotek Relative Viscometer Y501C.

CEILab color testing of the resins is conducted using a BYK TSC II Spectrophotometer. Resins are tested in transmission after being solvated. The most common dissolution condition is 25% solids in MEK (methyl ethyl ketone). CIELab measure the L* (light-darkness), a* (red-green color), and b* (blue-yellow color).

The following abbreviations are used throughout this specification:
Low Tg—low glass transition temperature
High Tg—high glass transition temperature
V2200B—Vitel 2200B
V3300B—Vitel 3300B
V3200B—Vitel 3200B
V3350B—Vitel 3350B
V3550B—Vitel 3550B
V3650B—Vitel 3650B

Materials used as the plastic mass to be packaged and as the film compositions surrounding the plastic mass of the following Examples are described as below:

Vitel 3300B: Low Tg Resin; Tg=18° C., Mw=63,000 Daltons, 100% amorphous copolyester resin

Vitel 3350B: Low Tg Resin; Tg=18° C., Mw=63,000 Daltons, 100% amorphous copolyester resin

Vite 3200B: Low Tg Resin; Tg=17° C., Mw=63,500 Daltons, 100% amorphous copolyester resin

Vitel 3550B: Low Tg Resin; Tg=−11° C., Mw=75,000 Daltons, 100% amorphous copolyester resin

Vitel 3650B: Low Tg Resin; Tg=−10° C., Mw=73,000 Daltons, 100% amorphous copolyester resin

Vitel 2200B: High Tg Resin, Tg=69° C., Mw=42,000 Daltons, 100% amorphous copolyester resin

Vitel 2250B: High Tg Resin, Tg=63° C., Mw=35,000 Daltons, 100% amorphous copolyester resin

Vitel 2100B: High Tg Resin, Tg=69° C., Mw=45,000 Daltons, 100% amorphous copolyester resin

Vitel 2300B: High Tg Resin, Tg=69° C., Mw=45,000 Daltons, 100% amorphous copolyester resin

The different compositions suitable for use as the low Tg copolyester plastic mass and the High Tg polymeric outer film include:

| Ingredient | Wt % Range |
|---|---|
| Low Tg Copolyester (core): V3300B, | 70-99.5% |
| V3200B, V3300S, V3350B, V3550B, | |
| V3650B | |
| High Tg Copolyester (skin): V2200B, | 0.5-30% |
| V2250B, V2300B | |

The preferred compositions that are suitable for use as the low Tg copolyester plastic mass and the High Tg polymeric outer film include:

| Ingredient | Wt % Range |
|---|---|
| Low Tg Copolyester (V3300B, V3200B, | 98-99.5% |
| V3350B, V3550B, or V3650B) - Core | |
| High Tg Copolyester (V2200B) - Skin | 0.5-2% |

The invention is further illustrated by way of the examples which are set forth below.

### EXAMPLES

### Example 1

An initial small scale trial was run, which proved that this technology is viable for these resins. During these trials 20 g pillows of Vitel 3300B with a Vitel 2200B skin were produced. There was excellent adhesion between skin and core.

### Specific Trial Data:

Skin Resin: Vitel 2200B was used, using a bulk melter at 210° C. and 6 bar pressure
Core Resin: Vitel 3300B was used, using a hot melt drum melter at 220° C. Rate: Achieved 100 kg/hr
Core-to-Skin Ratio: 49 to 1 (2% skin) and 19 to 1 (5% skin). 49 to 1 was more successful.
Extrusion Die Bath Temperature: Initially was set at 10° C. This caused delamination between skin and core. When the bath temperature was increased to 60-70° C. adhesion between the layers was excellent.
Analysis of the trial pillows (primarily NMR and DSC) showed negligible effect of the skin material on the bulk properties of the resin. The Tg of the resin was shifted by only 1.4° C. with the inclusion of the skin resin. Skin thickness was measured to be about 70 microns.

### Example 2

1. Optimizing adhesion between skin and core: Initial trials showed that if the water bath temperature immediately following the coextrusion die is too low (below 60° C.) there is little to no adhesion between the different resins of the core and skin. This causes the skin resin to crack and fall off, which results in resin blocking. As bath temperature is increased to about 65° C.-70° C., adhesion between the different resins is increased to acceptable levels.
2. Minimizing resin degradation: Preferably, it is desired to feed the core resin directly from the reactor to an extruder. Depending on exact feed rates of the coextruder, the resin may have to sit in the reactor at high temperatures from 1.5 to 3.5 hours. At standard reaction temperatures (250° C.), dwell times of this length may cause significant degradation of the final product. Degradation is defined as a drop in IV (Intrinsic Viscosity) greater than 0.1. There may also be a darkening of color (b* increase of 10+ units) associated with degradation. It is possible that a holding tank at a lower temperature will need to be used to feed the coextrusion line to minimize resin degradation and equipment capacity loss.
3. Cooling baths: It is critical that the extruded “pillows” are cooled sufficiently in the water bath before packaging in boxes. For example, if the Tg of the proposed skin resin is 70° C., and if the core resin is not eventually cooled below this, the resultant packages could easily end up blocking together. Assuming the core resin will be pumped directly from the reactor, the initial resin temperature at the die could be as high as 250° C., and thus, in order to produce non-blocking “packageless” packaging, the extruded “pillows” must be cooled to an acceptable temperature before being placed in a box or other shipping container.
4. Moisture level in resin: A blower at the exit of the water bath removes all excess water from the pillows. This is critical because when customers solvate the resin, the % moisture should be less than 0.15% to avoid problems with moisture curatives (e.g. isocyanates).

We claim:

1. A package, comprising:
a copolyester plastic mass having a finite size and shape, said copolyester plastic mass having a low glass transition temperature of 40° C. or less; and
a copolyester polymeric film surrounding said copolyester plastic mass, said copolyester polymeric film having a high glass transition temperature of 60° C. or more.

2. The package of claim 1 wherein said polymeric film has a thickness of 10 microns to 100 microns.

3. The package of claim 1 wherein said polymeric film has a thickness of 10 microns to 300 microns.

4. The package of claim 1 wherein said polymeric film has a thickness of 40 microns to 2000 microns.

5. The package of claim 1 wherein said low glass transition temperature is 35° C. or less.

6. The package of claim 1 wherein said low glass transition temperature is 20° C. or less.

7. The package of claim 1 wherein said high glass transition temperature is 65° C. or more.

8. The package of claim 1 wherein said high glass transition temperature is 68° C. or more.

9. The package of claim 1 wherein said plastic mass comprises 70-99.5% by weight of said package, and said polymeric film comprises 0.5-30% by weight of said package.

10. The package of claim 1 wherein said plastic mass comprises 98-99.5% by weight of said package, and said polymeric film comprises 0.5-2% by weight of said package.

11. A method of packaging a plastic mass, comprising the steps of:
providing a copolyester plastic mass, said copolyester plastic mass having a low glass transition temperature of 40° C. or less; and
surrounding the copolyester plastic mass with a copolyester polymeric film, said copolyester polymeric film having a high glass transition temperature of 60° C. or more.

12. The method of claim 11 wherein said copolyester polymeric film has a thickness of 10 microns to 100 microns.

13. The method of claim 11 wherein said copolyester polymeric film has a thickness of 10 microns to 300 microns.

14. The method of claim 11 wherein said copolyester polymeric film has a thickness of 40 microns to 2000 microns.

15. The method of claim 11 wherein said low glass transition temperature is 35° C. or less.

16. The method of claim 11 wherein said low glass transition temperature is 20° C. or less.

17. The method of claim 11 wherein said high glass transition temperature is 65° C. or more.

18. The method of claim 11 wherein said high glass transition temperature is 68° C. or more.

19. The method of claim 11 wherein the step of providing a copolyester plastic mass comprises extruding said copolyester plastic mass.

20. The method of claim 19 wherein the step of surrounding the copolyester plastic mass comprises coextruding the copolyester polymeric film.

21. The method of claim 20 wherein said extruded copolyester plastic surrounded with the copolyester polymeric film is cooled in a bath, the temperature of the bath being greater than the high glass transition temperature of the copolyester polymeric film.

22. The method of claim 20 further including the step to forming the extruded copolyester plastic mass and coextruded copolyester polymeric film into a unit of finite size and shape.

23. The method of claim 22 further including the step of sealing opposite ends of said unit.

24. The method of claim 1 wherein said plastic mass comprises 70-99.5% by weight of said package, and said polymeric film comprises 0.5-30% by weight of said package.

25. The method of claim 11 wherein said plastic mass comprises 98-99.5% by weight of said package, and said polymeric film comprises 0.5-2% by weight of said package.
